(19) United States
(12) Patent Application Publication
(10) Pub. No.: US 2013/0110018 A1
(43) Pub. Date: May 2, 2013

(54) HFCWO VEST

(71) Applicants: Barrett Reed Mitchell, Fayence (FR); Fabio Lupi, Albano Lazio (IT); Paolo Gianangeli, Pomezia (Roma) (IT); Giovanni Poldi, Albano Laziale-RM (IT); Giulio Malerba, Roma (IT); Marco Pontesilli, Ciampino (RM) (IT)

(72) Inventors: Barrett Reed Mitchell, Fayence (FR); Fabio Lupi, Albano Lazio (IT); Paolo Gianangeli, Pomezia (Roma) (IT); Giovanni Poldi, Albano Laziale-RM (IT); Giulio Malerba, Roma (IT); Marco Pontesilli, Ciampino (RM) (IT)

(73) Assignees: Christine Y.P.A. MITCHELL, FAYENCE (FR); Barrett Reed MITCHELL, FAYENCE (FR)

(21) Appl. No.: 13/521,495

(22) PCT Filed: Jan. 18, 2011
(86) PCT No.: PCT/EP11/50603

§ 371 Date: Jan. 18, 2013

(30) Foreign Application Priority Data
Jan. 18, 2010 (EP) 10305050.6
Jan. 18, 2010 (EP) 10305051.4

(51) Int. Cl. A61H 9/00

(52) U.S. Cl. CPC A61H 9/0007
USPC 601/149

(57) ABSTRACT

A medical vest (2) for High Frequency Chest Wall Oscillation treatments (HFCWO), including a compartment configured to be successively inflated and deflated to perform repetitive compressions to a user's body, characterized in that the vest (2) further includes at least one other compartment configured such as the at least two compartments are adapted to be inflated and deflated independent of each other.

The invention relates in general to a medical device applying repetitive compressions to the body of a human helping her/him to loosen mucus from the lungs and trachea, and improve the blood circulation.

More specifically, the present invention relates to High Frequency Chest Wall Oscillation (HFCWO) therapy systems, especially but not limited to HFCWO therapy systems suitable for use in a hospital or in a healthcare facility and home care use.

Under normal conditions, the human body efficiently clears mucus from the lungs and the respiratory tract by way of coughs.

Irregularities in the normal mucociliary transport system or hyper secretion of respiratory mucus results in an accumulation of mucus in the lungs causing severe medical complications such as hypoxemia, hypercapnia, chronic bronchitis and pneumonia.

Abnormal respiratory mucus clearance is a manifestation of many medical conditions such as pertussis, cystic fibrosis, atelectasis, bronchiectasis, cavitating lung disease, vitamin A deficiency, chronic obstructive pulmonary disease (COPD), asthma, and immotile cilia syndrome. Exposure to cigarette smoke, air pollutants and viral infections also negatively affect mucociliary function. Post surgical patients, paralyzed persons, long term care bedridden patients, and newborns with respiratory distress syndrome also exhibit reduced mucociliary transport.

Chest physiotherapy is a well-known method for treating patients with one or more of the above health conditions.

Several methods of chest physiotherapy exist.

Traditionally, care providers perform Chest Physical Therapy (CPT) one to four times per day. CPT consists of a patient lying in one of twelve positions while a caregiver “claps” or pounds on the chest and back over each lobe of the lung. To treat all areas of the lung in all twelve positions requires pounding for half to three-quarters of an hour along with inhalation therapy. CPT clears the mucus by shaking loose airway secretions through chest percussions and postural draining of the loosened mucus toward the mouth. Active coughing is required to ultimately expectorate the loosened mucus. CPT requires the assistance of a trained caregiver, often a family member if a nurse or respiratory therapist is not available. It is a physically exhausting process for both the CF patient and the caregiver.

Artificial respiration devices for applying and relieving pressure on the chest of a person have been used to assist lung breathing functions, by loosening and helping the elimination of mucus from the lungs of persons with cystic fibrosis (CF). These devices use jackets having air accommodating bladders that surround the thorax of the patient. The bladder worn around the thorax of the CF patient repeatedly compresses and releases the thorax at frequencies as high as 25 cycles per second. Each compression produces a rush of air through the lobes of the lungs that shears the secretions from the sidewalls of the airways and helps move them toward the larger central bronchial airways where they can be expectorated by normal coughing.

One of the most efficient treatments is the High Frequency Chest Wall Oscillation (HFCWO) also commonly referred to as airway clearance jackets or vests. Treatments using HFCWO are well-known in the art.

Existing solutions describe a vest connected to a pulsed air generator via a tube. The entrance of the tube in the vest is reversible so the generator can be positioned on both sides of the vest while in use. So the vest receives pulsed air that inflates and deflates it. This helps the mucociliary transport activity.

However, this system could still be improved in terms of efficiency.

The purpose of the present invention is to propose a device and a method to solve the above efficiency problems found with HFCWO systems according to the prior art.

In a more specific manner, the invention relates to a medical vest for High Frequency Chest Wall Oscillation (HFCWO) treatment, comprising a compartment configured to be successively inflated and deflated to perform repetitive compressions on a user's body. The vest further comprises at least one other compartment configured such as the at least two compartments are adapted to be inflated and deflated independent of each other.

Thus multiple compartments provided within the vest, said multiple compartments being inflatable independent of each other, allow for adaption of the oscillations according to the location on the body. We further noticed that such local customization enables increasing efficiency of the vest.

Preferably, the vest comprises a back and a front comprising at least one compartment each. The vest is arranged so that it is possible to inflate at least a compartment of the front independently of at least a compartment of the back of the vest.

Additionally, we noticed, that post surgical patients for example with respiratory distress syndrome will exhibit reduced mucociliary transport as well, yet they might not be able to use the vest as described in the prior art, since applying compression to a recent surgical wound is painful and damaging. These patients will then have to wait for the wound to heal before they can use the vest described above which may prolong their stay in hospital. This is an important disadvantage with the state of the art.

As an additional benefit, the present invention will further provide a HFCWO system and a vest that can also be safely used by post surgical patients, without compromising the healing process of their wound and causing them unnecessary pain.

Indeed, it can be customized to not inflate over the wound area. This allows post surgical patients with respiratory distress syndrome to put on a treatment vest, and to receive the necessary HFCWO treatment without compromising the healing process of their wound and causing them unnecessary pain.

The at least two compartments are configured to be deflated independent of each other. In fact, every compartment can be autonomously inflated and deflated. While one or more compartment will be used in a specific treatment, others will not be used. The choice of compartments in use depends primarily on the suitable treatment for the patient, and if he/she has any areas where pressure might cause damage or similar.

The invention may also comprise at least one of the following optional features.

In one embodiment, the back and the front of the vest are configured to be two separate compartments. Furthermore, the back and the front of said vest comprise at least one compartment each. Also, the number of compartments in the front of the vest is independent of the number of compartments in the back of the vest. The size of a first compartment may be independent of the size of a second compartment.

The vest comprises control means configured to control the flow of air admitted into the vest. By the flow of the air, we mean either one of the frequency and/or the volume or both.

A first valve is configured to control the pressured air flow in a first compartment of the vest and a second valve is configured to control the pressured air flow in a second compartment of the vest. Said valves can be integrated in the vest. The valves can also be separate from the vest. In one embodiment, said valves are comprised in an apparatus different from the vest and where said valves are connected to the vest by air conducting tubes. In another embodiment, at least one of said valves is integrated in the vest and at least one valve is comprised in an apparatus different from the vest and connected thereto.

A first valve is configured to control the pressured air flow in a first compartment of the vest, a second valve is configured to control the pressured air flow in a second compartment of the vest. At least one of said first and second valve is integrated in the vest.

The system also comprises a plurality of valves, where at least one valve is comprised in an apparatus different from the vest and where said valve are connected to the vest by air conducting tubes.

In another embodiment, a plurality of compartments positioned in a substantially vertical order on the vest when in use, and configured to be subsequently inflated starting with the compartment located the lowest and finishing with the compartment located the highest. This gives the impression of sending pulses through the body of the user starting from the bottom of the vest and moving to the top creating a “push” toward the mouth of the patient to facilitate the expectoration. The inverse order is also relevant to the invention. Furthermore, a combination alternating between the two directions in a back and forward motion is advantageous.

According to an advantageous embodiment, at least a compartment has a rigid material oriented toward an exterior part of the vest and a flexible or resilient material oriented toward an interior part of the vest.

Thus the compartment has a rigid material oriented toward the exterior part of the vest and a flexible material oriented toward the interior part. This embodiment is advantageous to orientate the compression movements, resulting from inflating the vest compartments, inwards towards the body of the patient who wears it.

The exterior part of the vest is a part oriented toward the exterior of the vest when in use. The interior part of the vest is a part oriented toward the interior of the vest when in use.

Preferably, at least a compartment is at least partially elastic. This means that the envelope wherein the air flows in and out is at least partially elastic.

The invention also describes an HFCWO vest, comprising at least a compartment configured to be successively inflated and deflated to perform repetitive compressions to a user's body and wherein the at least one compartment comprises a first portion that is oriented toward an exterior part of the vest, said first portion of the compartment or said exterior part of the vest being non elastic and wherein said compartment comprises at least a second portion that is oriented toward the chest of the patient during usage or that is oriented toward an interior part of the vest, said second portion of the compartment or said interior part of the vest being elastic.

Thus according to a first embodiment, the vest has an exterior and an interior parts. Each compartment is an envelope that is inserted between these exterior and interior parts.

According to a first embodiment, the exterior part is rigid or is not elastic.

The interior part of the vest is elastic or resilient and/or the second portion of the compartment, i.e., the portion that is, during usage, oriented toward the chest is elastic or resilient. It can be possible that only one among the interior part and the second portion is elastic. Then the other can be flexible even if not elastic. The first portion of the compartment, i.e., the portion that is oriented toward the exterior in use is preferably not elastic but is preferably flexible or rigid. The first portion of the compartment is adjacent the exterior part of the vest. In case the exterior part of the vest is rigid, then the first portion of the compartment can be elastic.

A material is referred to as elastic or resilient if it tends to returns to its original form or position after being expanded or dilated. When being expanded the material is deformed. Thus the material of an elastic compartment expands or dilates in order to inflate the compartment. When expanded, the material exercises a force that tends to retract the compartment and to bring it back to its deflated position. On the contrary, the material of a compartment that is flexible but that is not elastic does not expand or dilate in order to inflate the compartment. When such compartment deflates, the material folds but does not exercises a force that retracts the compartment.

These embodiments are particularly advantageous since they allow facilitating the deflation of the compartment, which enables a faster and more complete evacuation of the air out of the compartment without requiring depressurization devices for sucking the air. Higher amplitudes can therefore be achieved without increasing complexity of the system.

These features are particularly advantageous in embodiments wherein the compartment exhibits a single port from which air flows in for inflation and flows out for deflation. Indeed, with these compartments, a device for sucking the air out of the compartment is usually required in order to obtain a high amplitude between the inflated and the deflated positions of the compartment.

These embodiments also improve the comfort of the patient through helping him inspiring when the compartment deflates while maintaining an efficient transmission of the effort toward to the chest of the patient during inflation of the compartment.

All the features of these embodiments can be combined with all features of the embodiments described previously and here below. The features related to elastic portions or part can also be implemented in a vest that does not comprise compartments in the back and in the front that can be independently inflated.

The present invention also refers to a medical system for generating air pressure in a vest comprising a vest being at least partially resilient, an air supply configured to send pressured air into at least part of said vest, at least one valve configured to be connected to the air supply at one end and to the vest at another end, where the at least one valve is configured to intercept and to control the pressured air flowing into at least part of said vest. Said vest has at least two compartments configured to be inflated independent of each other.

Preferably, the vest comprises a back and a front comprising at least one compartment each and in the vest is arranged so that it is possible to inflate the front independently of the back.

The system according to the invention may also comprise at least one of the following optional features.

The system comprises a plurality of valves. At least one valve is comprised in an apparatus different from the vest and said valve is connected to said vest by air conducting tubes.

The system comprises a main valve connected to several local valves, the local valves being individually connected to the compartments of the vest and the main valve distributing the compressed air flowing in from the air supply to the local valves.

The main valve is configured to distribute pressured air to said local valves alternately or simultaneously.

According to a specific embodiment, the main valve is physically similar to the local valves. This significantly reduces the complexity and cost for obtaining the system.

The local valves are configured to alternate between letting at least part of the pressured air pass through to a first compartment of the vest, letting pressured air pass through to at least a second compartment of the vest and releasing the pressured air from the vest to the outside of said system.

Each local valve has an outlet, said outlet being connected to the outside of the vest for deflating the compartment associated to said each local valve.

Each local valve is integrated in its associated compartment or attached onto its associated compartment. The main valve is located outside of the vest. Thus, each local valve can be adapted to its associated compartment thereby allowing controlling the frequency or the volume of the pulses provided to each compartment. Thus, the vest comprising the local valves can be precisely adapted to each treatment. The main valve is shared by the local valves and can be the same for various treatments. This significantly facilitates the logistic in healthcare facilities where many treatments are provided.

Preferably, each compartment has a single port for air flowing in and out of the compartment.

According to a specific embodiment, at least one valve is integrated in the vest.

According to an advantageous embodiment, the system comprises an air supply configured to provide pressured air in a substantially steady stream to the at least one valve.

Preferably, the valve comprises a main outer part and an inner part configured to move in relation to said outer part. The valve is configured so that the inner part performs a rotational movement in relation to said outer part.

The inner part comprises at least a recess provided longitudinally in relation to the inner part. The outer part has a cylindrical body and the inner part is a shaft referred to as rotary piston that rotates inside the outer part.

The valve is configured to control the amount of pressured air let through to the wearable body by movements of the inner part.

The valve is configured to release the pressured air from wearable body to the outside of said system by movements of the piston.

The valve is configured to alternate between letting pressured air pass through the valve to the vest and releasing the pressured air from the vest to the outside of said system.

Preferably, the valve is configured so that: in a first position of the inner part relative to the outer part, the compartment is in communication with the air supply and is not in communication with the outside allowing thereby the compartment to inflate; in a second position of the inner part relative to the outer part, the compartment is in communication with the outside and is not in communication with the air supply, allowing thereby the compartment to deflate.

Advantageously, the air supply is a pressured air distribution of a building and/or comprises means for storing pressured air under a liquid or gaseous state. According to another embodiment, the air supply comprises a compressor.

The system further comprises a user interface allowing a user of the system to control the movements and frequency of the inner part in relation to the outer part.

The wearable body is preferably worn on the upper body of a human.

The present invention further relates to a method for generating air pressure in a vest comprising sending pressured air from an air supply into at least part of said vest and connecting at least one valve to the air supply at one end and to the vest at another end, where the at least one valve intercepts and controls the pressured air flowing into at least part of said vest and where said vest comprises at least two compartments being inflated independent of each other.

The invention also describes a method of generating air pressure in a medical system or in a medical vest for HFCWO treatments according to any one of the previously mentioned features. The method comprises the steps of: sending pressured air from an air supply into the vest; connecting at least one valve to the air supply and connecting at least a compartment of the front and at least a compartment of the back of the vest to the at least one valve; inflating and deflating at least the front independently of the back.

The invention also describes a method of generating air pressure in a wearable body, said wearable body being at least partially resilient, the method comprising the following steps: sending pressured air from an air supply into at least part of said partially resilient body; said air supply is sending pressured air in a steady stream into at least part of said partially resilient body; and in that said steady stream of pressured air is passing through at least one valve before reaching at least part of said wearable body; said valve intercepts and controls the frequency of pressured air flowing into at least part of said wearable body.

A preferred embodiment of the invention will now be described in further details according to the drawings.

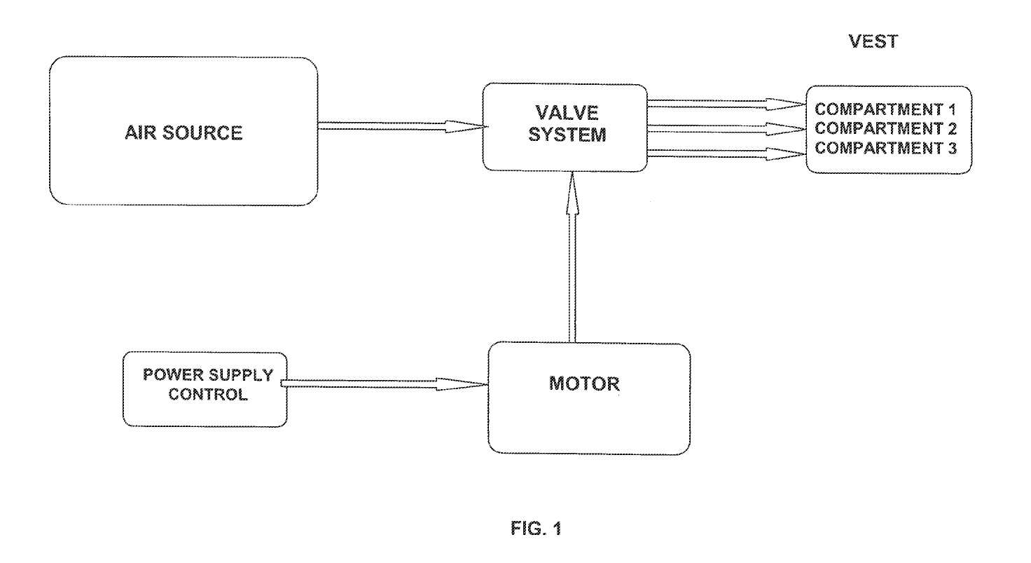

FIG. 1 shows a schematic view of the generic system according to the invention.

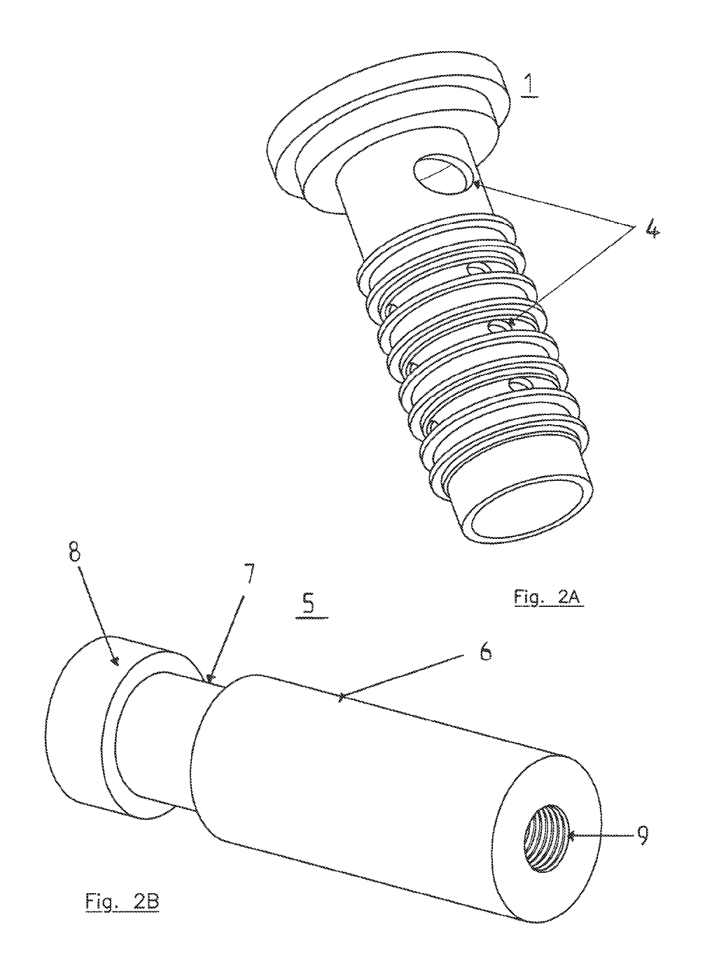

FIG. 2a shows the valve cylinder according to the invention without the piston.

FIG. 2b shows the piston of the present invention.

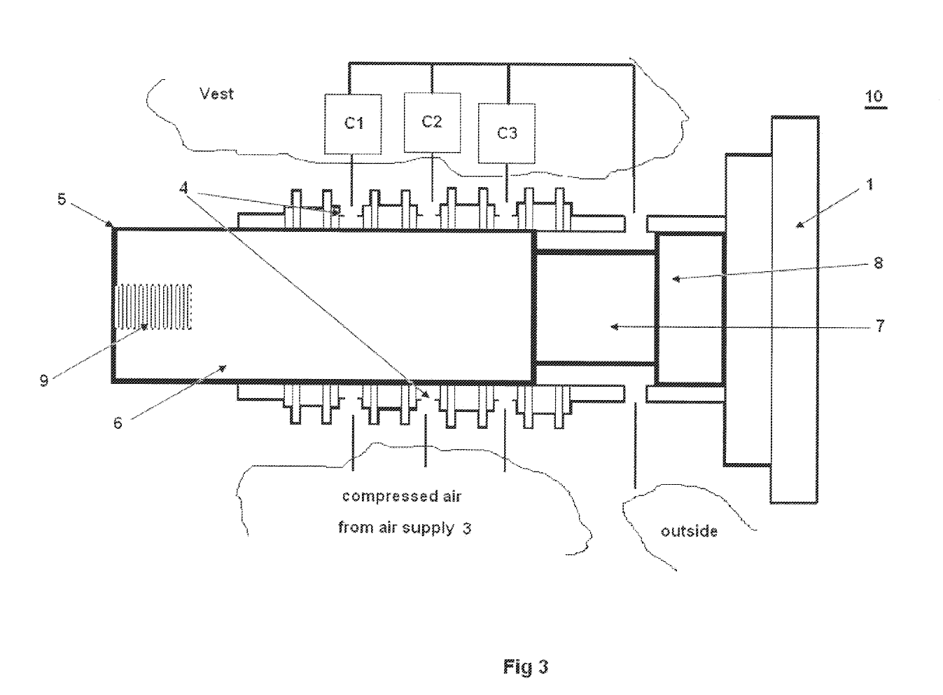

FIG. 3 shows the assembled valve in a first position according to the present invention, connected to different jacket compartments.

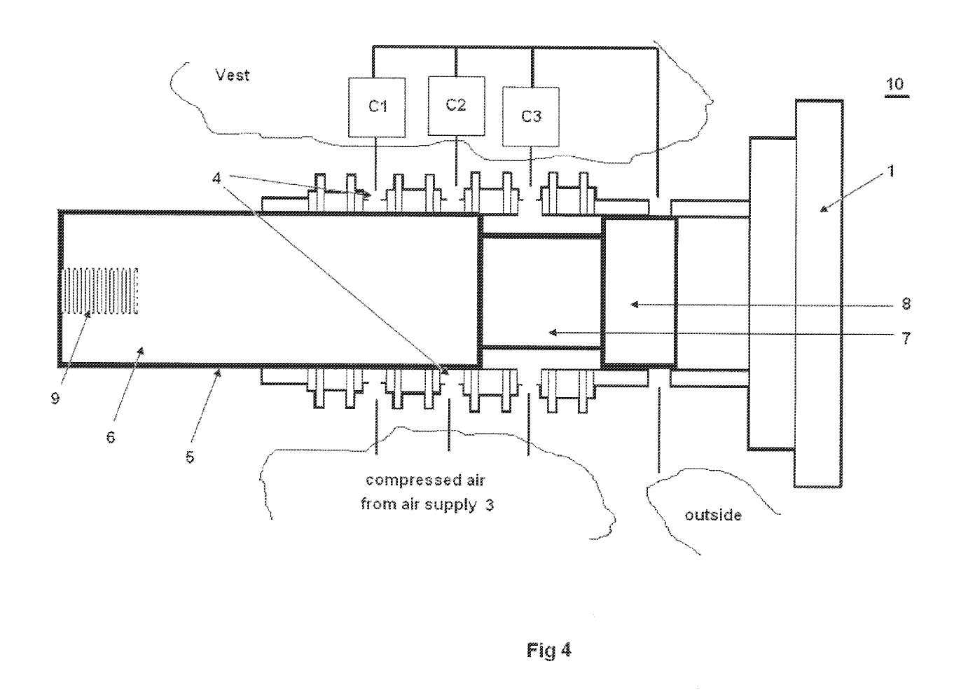

FIG. 4 shows the assembled valve in a second position according to the present invention, connected to different jacket compartments.

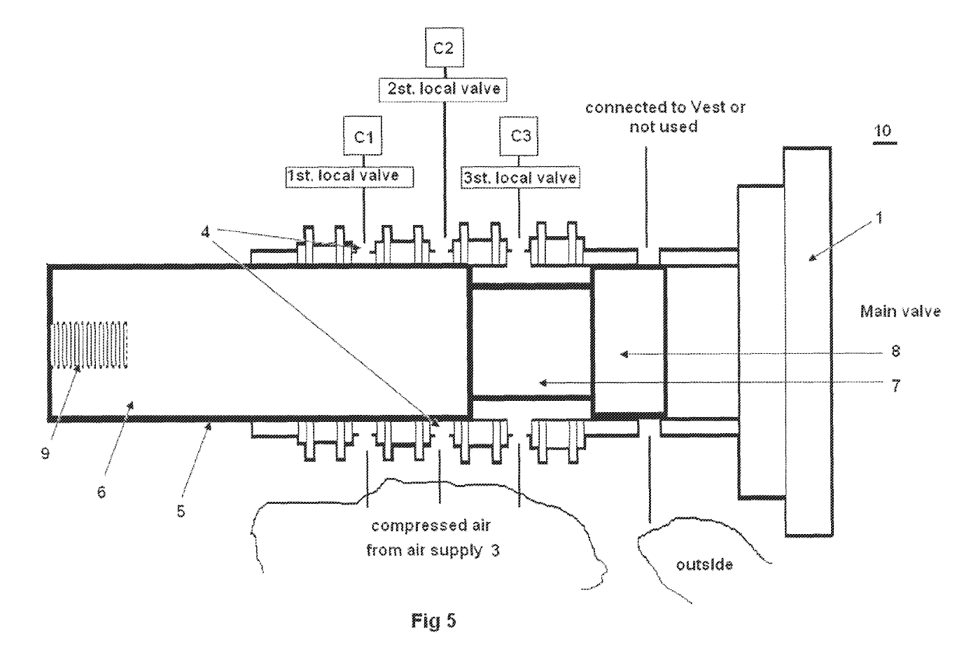

FIG. 5 shows the main valve connected to local valves, each one connected to a different compartment of the jacket.

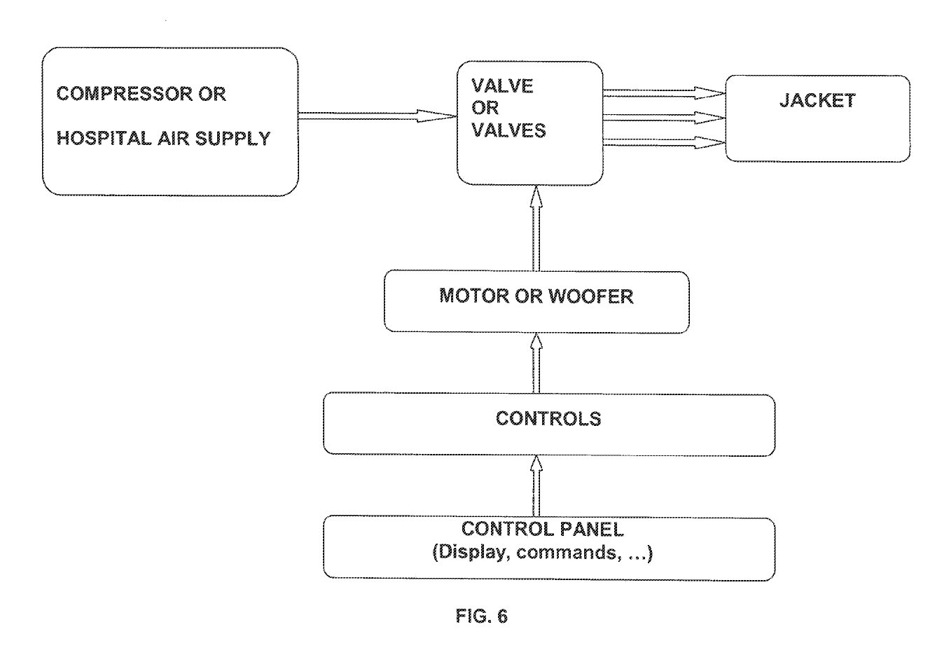

FIG. 6 represents a generic flow chart of the system according to the invention.

FIG. 1 shows an air supply connected to a valve according to the invention. The air supply could for example be a compressor providing compressed air. The compressed air is either continuously provided in a steady stream meaning with a constant flow and volume of air or as pulsed air from i.e. an air pulse generator. The valve connects the air supply to the compartments of the jacket. In this embodiment, the valve is driven by a motor connected to a power supply. However the valve could also be driven by a magnetic system as described earlier. The valve has several options for controlling the compressed air pushed into it. In the main two, the compressed air is either blocked by a closed valve blocking the flow into the jacket compartments, or allows it through by an open valve, which will inflate the compartments of the jacket connected thereto. Further options will be revealed to the reader later in this document.

The jacket is either fully made of a material that is flexible, or of a combination of resilient parts and rigid parts. More particularly, the jacket compartments are either fully made of a material that is flexible, or of a combination of resilient parts and rigid parts. The jacket compartments could for example have a rigid material for the exterior part of the jacket and a flexible material for the interior part. This last embodiment is preferred to orientate the compression movements, resulting from inflating the jacket compartments, inwards towards the body of the patient who wears it.

FIGS. 2a and 2b show the valve according to the invention in further details. In FIG. 2a, we see a drawing of the valve comprising an outer part. Preferably, the outer part forms a cylinder 1. The cylinder 1 is hollow configured to receive an inner part. According to a particular embodiment the inner part is a piston 5 that is configured to perform a sliding movement along the longitudinal axis of the valve cylinder 1. The cylinder 1 further comprises one or more holes 4 or ports of equal or different sizes. The holes 4 are preferably aligned in two rows, each row having the same number of holes and are substantially facing each other. The cylinder 1 is preferably made of stainless steel or aluminum.

FIG. 2b reveals the piston 5 configured to make translational movements along the shared longitudinal axis of the cylinder 1 and the piston 5. In one embodiment where the piston 5 is driven by a motor, an opening at one extremity is provided with internal threads to fasten the piston 5 to the mechanical countershaft of the motor (not shown in the figures). In another embodiment, the piston 5 is driven by other means that does not require a motor, and the piston 5 has therefore no opening in its extremity. The piston 5 is preferably made of PEEK (Polyether ether ketone). PEEK is a material that enables a continuous lubrication while sliding inside the cylinder 1 to give the minimum level of friction.

Physically, the piston 5 could be described as having a body 6, a neck 7 and a head 8. The body 6 and the head 8 of the piston 5 have the same diameter while the neck 7 has a diameter that is inferior to the diameter of the body 6 and head 8.

The piston 5 is preferably machined from one piece, what is also referred to as a mono-bloc.

It should be noted that the piston neck 7, can also be provided longitudinally in relation to the piston as a piston groove or recess. The inner part, i.e., the piston may rotate as a shaft clockwise and anticlockwise instead of up and down.

The piston can also rotate around a single direction.

All features described in relation to a sliding piston can be combined with a rotating inner part.

According to a specific embodiment wherein the inner part rotates, the various recesses of the inner part are not aligned but they mutually present an angular offset. The valve is arranged so that in a first position of the inner part relative to the outer part, a first recess can enable communication between ports of a first pair of ports of the outer part while a second recess prevents communication between ports of a second pair of ports of the outer part. In a second position the second recess enables communication between the ports of the second pair of ports of the outer part while the first recess prevents communication between the ports of the first pair of ports.

The sequence and duration of the communication of each pair of ports can be determined according to the angular offset and size of the recesses.

First and second pair of ports can be dedicated to a single compartment. In this case, a pair can be dedicated to in flows while the other pair is dedicated to out flows.

According to an alternative embodiment, the first pair of ports is dedicated to a first compartment or group of compartments, while the second pair of ports is dedicated to a second compartment or group of compartments.

Several recesses can be provided giving the possibility for inflating compartment 1 followed by compartment 2 and then compartment 3 of the vest by a clockwise movement of the piston, and then compartment 3, 2 and 1 in this order by an anticlockwise movement of the piston. The speed rotation of the piston can be variable as well, which makes randomness even easier to introduce when requested.

Another embodiment would be to have a translational movement combined with a rotation movement including both the neck and the recess of the piston.

FIG. 3 and FIG. 4, show the assembled valve 10 comprising the valve cylinder 1 and the piston 5. In this embodiment, jacket compartments C1, C2 and C3 of the jacket 2, are connected to a first row of holes 4 provided in the valve cylinder 1. The second row of holes 4 is mainly connected to the compressed air supply 3, however with one hole reserved for an outlet connected to the exterior when releasing the compressed air from the compartments C1, C2 and C3 of the jacket 2.

When the piston 5 is in an idle or first position, the compartments C1, C2 and C3 of the jacket 2 is in fact in contact with the outside through the valve 10. That is the actual situation shown in FIG. 3. This is achieved by aligning the neck 7 of the piston 5 with a hole connected to a common outlet of the compartments C1, C2 and C3 of the jacket 2 on one side, and the hole of the valve 10 leading to the exterior/outside on the other side. Like this, the compressed air that might be retained in the compartments C1, C2 and C3 of the jacket 2, will flow through the valve 10, passing around the neck 7 of the piston and out through a hole 4 in the valve cylinder 1 to the outside. The other holes 4 connected to the supply 3 of compressed air are blocked by the body 6 of the piston 5, since it fills out the diameter of the valve cylinder 1 and is thereby air-tight.

In FIG. 4, the piston 5 is moved to a second position, thereby blocking the passageway between the common outlet of the compartments C1, C2 and C3 of the jacket 2 and the outside with the piston head 8, and opening a passage between the supply 3 of compressed air and i.e. one compartment C3 of the jacket 2 by positioning the piston neck 7 between these respective holes 4 as shown on the figure. In this position the valve 10 allows the compartment C3 of the jacket 2 to be inflated by compressed air.

With the piston 5 moving forth and back between the two positions shown in FIGS. 3 and 4, the compartment C3 of the jacket 2 will be alternately inflated and deflated with a frequency depending on the motor connected to the piston 5 or the alternative driving mechanism used to activate the piston 5, for example a woofer. This frequency can be set by the operator of the system as shown in FIG. 4.

The FIGS. 3 and 4 represent only one embodiment. Other movements of the piston, it is possible to inflate and deflate other compartments either sequentially, simultaneously or as a combination of both. Two compartments could for example be inflated simultaneously. Then while deflating them, a third compartment will be inflated and so on. This would require a different positioning of the holes 4 in the cylinder 1 and a piston 5 with the appropriate proportions.

FIG. 6 represents a generic flow chart of the system according to the invention. We can see that one valve 10 can be replaced by several valves working cooperatively in series. The valves can be identical but can also be different, for example, they could have a different number and different size of holes 4. The pistons 5 can move synchronously or independent of each other. The pistons 5 however move according to a predefined structure set by the operator of the system using the control panel. In a different embodiment, one predefined program may consist of moving one or more pistons 5 randomly for a certain amount of time.

In FIG. 5 a main valve 10 is connected to several local valves as shown. The local valves are then individually connected to the compartments of the jacket 2. The main valve 10, being physically similar to the local valves, distributes the compressed air flowing in from the air supply 3, to these local valves either by turn, one by one, or still by turn but two or more at a time.

Since the local valves may have their own outlet to connect to the outside and thereby deflating the compartments C1, C2 and C3 of the jacket 2 as such, the outlet of the main valve 10 connected to the outside as seen in FIG. 5 might not be used. While developing the present invention, this feature has turned out to be very advantageous, in particular in an embodiment wherein the compartment has a single port or hole for air flowing in and out. This embodiment allows reducing the cost of the vest and the system while preserving its efficiency and enhancing its reliability.

Alternatively, it might be used as a main outlet connecting several local outlets from local valves (not shown).

The advantage of having several valves is that each local valve can be connected to a specific compartment of the jacket 2, independent of and isolated from other compartments. In one embodiment, the jacket 2 has two compartments: one front compartment and one back compartment. By having a separate valve 10 for each compartment, it is possible to inflate the front of the jacket 2 independently of the back and vice versa. They could be inflated by turn i.e., sequentially to create alternating but cooperative compressions. It also becomes possible to inflate only one compartment while keeping the other inactive. This allows a more controllable and focused treatment using the jacket 2.

There is no limit to the number of compartments a jacket 2 might possess. In fact, the more compartments a jacket 2 has, the more personalized and customizable the treatment will be.

It is still possible to have a high number of compartments in a jacket 2 and keeping the number of valves relatively low. Each valve can be connected to a number of jacket compartments only limited by the number of holes 4 provided in the valve.

Throughout this document, we described as an example the valves of the system as inlet valves, meaning that the valves control the air let in to the jacket. Similarly, in another embodiment, the invention can be realized by controlling the pulsations with identical exit valves. This is done by letting a steady stream of pressured air into the vest and creating the pulses by decreasing the pressure when the valve is aligned to the outside and increasing the pressure when that outlet valve is closed and the internal vest pressure goes up again.

Although illustrative embodiments of the present invention have been described in detail with reference to the accompanying drawings, it is to be understood that the invention is not limited to those precise embodiments and that changes and modifications may be effected therein by those in the art without departing from the scope and spirit of the invention.

1. A medical vest (2) for High Frequency Chest Wall Oscillation treatments (HFCWO), comprising a compartment configured to be successively inflated and deflated to perform repetitive compressions to a user's body, the vest (2) further comprises at least one other compartment configured such as the at least two compartments are adapted to be inflated and deflated independent of each other characterized in that the vest (2) comprises a back and a front comprising at least one compartment each and in that the vest (2) is arranged so that it is possible to inflate the front independently of the back and vice versa.

2. A vest (2) according to claim 1 comprising control means configured to control the flow and/or the volume and/or the frequency of air admitted into the vest (2), said control means comprising at least one valve (10) configured to control the pressured air flow in at least a first compartment of the vest (2) and at least a second valve (10) configured to control the pressured air flow in at least a second compartment of the vest (2).

3. A vest (2) according to claim 1, configured so the at least two compartments are inflated in a first predetermined order and deflated in a second predetermined order different from the first predetermined order.

4. A vest (2) according to claim 1, wherein the at least two compartments are inflated and deflated randomly.

5. A vest (2) according to claim claim 1, comprising a plurality of compartments positioned in a substantially vertical order on the vest (2) when in use, configured to be subsequently inflated starting with the compartment located the lowest and finishing with the compartment located the highest and configured to be subsequently deflated starting with the compartment located the highest and finishing with the compartment located the lowest.

6. A vest (2) according to claim 1 wherein at least a compartment has a rigid material oriented toward an exterior part of the vest (2) and a flexible material oriented toward an interior part of the vest (2).

7. A vest (2) according to claim 1 wherein at least a compartment is at least partially elastic.

8. A vest (2) according to claim 7 wherein said compartment comprises at least a first portion that is oriented toward an exterior part of the vest (2), said first portion of the compartment or said exterior part of the vest (2) being non elastic and wherein said compartment comprises at least a second portion that is oriented toward the chest of the patient during usage or that is oriented toward an interior part of the vest (2), said second portion of the compartment or said interior part of the vest (2) being elastic.

9. A medical system for generating air pressure in a vest (2) according to claim 1 comprising
A vest (2) being at least partially resilient,
An air supply configured to send pressured air into said vest (2),
At least one valve (10) configured to be connected to the air supply at one end and to the vest (2) at another end,
The at least one valve (10) is configured to intercept and to control the pressured air flowing into said vest (2).
Said vest (2) has at least two compartments configured to be inflated independent of each other.
characterized in that the vest (2) comprises a back and a front comprising at least one compartment each and in that the vest (2) is arranged so that it is possible to inflate the front independently of the back.

10. A medical system according to claim 9 comprising a plurality of valves (10), where at least one valve (10) is comprised in an apparatus different from the vest (2) and where said valve (10) is connected to said vest (2) by air conducting tubes.

11. A medical system according to claim 9 comprising a main valve connected to several local valves (10), the local valves (10) being individually connected to the compartments of the vest (2) and the main valve distributing the compressed air flowing in from the air supply.

12. A medical system according to claim 11 wherein the main valve is configured to distribute pressured air to said local valves (10) alternately or simultaneously.

13. A medical system according to claim 11 wherein the main valve is physically similar to the local valves (10).

14. A medical system according to claim 11 wherein said local valves (10) are configured to alternate between letting at least part of the pressured air pass through to a first compartment of the vest (2), letting pressured air pass through to at least a second compartment of the vest (2) and releasing the pressured air from the vest (2) to the outside of said system.

15. A medical system according to claim 11 wherein each local valve (10) has an outlet, said outlet being connected to the outside of the vest (2) for deflating the compartment associated to said each local valve (10).

16. A medical system according to claim 15 wherein each local valve (10) is integrated in its associated compartment or attached onto its associated compartment and wherein the main valve is located outside of the vest (2).

17. A medical system according to claim 9, where said at least one valve (10) is integrated in the vest (2).

18. A medical system according to claim 9, comprising an air supply (3) configured to provide pressured air in a substantially steady stream to the at least one valve (10).

19. A medical system according to claim 18 where said valve (10) comprises a main outer part (1) and an inner part (5) configured to move in relation to said outer part (1), the valve (10) being configured so that the inner part (5) performs a rotational movement in relation to said outer part (1).

20. A medical system according to claim 19, where the inner part (5) comprises at least a recess provided longitudinally in relation to the inner part.

21. A medical system according to claim 19, where said valve (10) is configured so that:
in a first position of the inner part (5) relative to the outer part (1), the compartment is in communication with the air supply (3) and is not in communication with the outside allowing thereby the compartment to inflate,
in a second position of the inner part (5) relative to the outer part (1), the compartment is in communication with the outside and is not in communication with the air supply (3), allowing thereby the compartment to deflate.

22. A medical system according to claim 9 wherein each compartment has a single port for air flowing in and out of the compartment.

23. A medical system to claim 9, where the air supply (3) is a pressured air distribution of a building and/or comprises means for storing pressured air under a liquid or gaseous state.

24. A method for generating air pressure in a medical vest (2) for HFCWO treatments according to claim 1 comprising the steps of:
sending pressured air from an air supply into said vest (2),
connecting at least one valve (10) to the air supply and connecting at least a compartment of the front and at least a compartment of the back of the vest (2) to the at least one valve (10),
characterized in that it comprises the step of inflating and deflating at least the front independently of the back.
